(19) United States
(12) Patent Application Publication
(10) Pub. No.: US 2011/0246239 A1
(43) Pub. Date: Oct. 6, 2011

(54) DISTRIBUTED PATIENT REGISTRIES FOR FEDERATED PACS

(75) Inventors: Richard Vdovjak, Eindhoven (NL); Anca Ioana Daniela Bucur, Eindhoven (NL); Johan Gerhard Herman Reuzel, Eindhoven (NL)

(73) Assignee: KONINKLIJKE PHILIPS ELECTRONICS N.V., EINDHOVEN (NL)

(21) Appl. No.: 13/133,395

(22) PCT Filed: Nov. 19, 2009
(86) PCT No.: PCT/IB09/55188

§ 371 Date: Jun. 8, 2011

Related U.S. Application Data
(60) Provisional application No. 61/138,319, filed on Dec. 17, 2008.

(51) Int. Cl. G06Q 50/00; G06Q 10/00

(52) U.S. Cl. 705/3

(57) ABSTRACT

A system having a local image storage element storing patient studies indexed by a local patient identifier, a local identity storage element storing a local identity list including a global patient identifier corresponding to each of a plurality of patients having studies stored on the local image storage element and one or more of the local patient identifiers corresponding to each of the patients, the local identity list being a subset of a global identity list stored remotely from the local identity storage element and a local location storage element storing a local index of the patient studies stored on the local image storage element and further patient studies stored on further local image storage elements for each of the plurality of patients, the index including a storage location of each study and the corresponding global patient identifier, the local index being a subset of a global index stored remotely.

### BACKGROUND

Some of the largest hospitals in the United States are federated health care organizations comprising many autonomous hospital sites. Each autonomous hospital site will typically include its own facilities for conducting tests, studies, investigations, procedures, and etc. on patients and storing the results thereof, including patient images. One common system for storing such results is a Picture Archiving Communication System (“PACS”).

A federated health care organization may wish to integrate the PACS of its various hospital sites in order to provide data sharing across the entire organization or federation.

### SUMMARY OF THE INVENTION

A system having a local image storage element storing patient studies, each patient study being indexed by a local patient identifier, a local identity storage element storing a local identity list including a global patient identifier corresponding to each of a plurality of patients having studies stored on the local image storage element and one or more of the local patient identifiers corresponding to each of the plurality of patients, wherein the local identity list is a subset of a global identity list stored remotely from the local identity storage element and a local location storage element storing a local index of the patient studies stored on the local image storage element and further patient studies stored on further local image storage elements for each of the plurality of patients, the index including a storage location of each study and the corresponding global patient identifier, wherein the local index is a subset of a global index stored remotely from the local location storage element.

A method for sending a first query including a local patient identifier, determining whether a local identity list includes the local patient identifier, receiving, when the local identity list includes the local patient identifier, a global patient identifier stored in the local identity list corresponding to the local patient identifier and sending, when the local identity list does not include the local patient identifier, the first query to a global identity list stored remotely from the local identity list, wherein the local identity list is a subset of the global identity list.

A system having a plurality of local image storage elements storing patient studies, each patient study being indexed by a local patient identifier, a plurality of local identity storage elements storing a local identity list including a global patient identifier corresponding to each of a plurality of patients having studies stored on a corresponding one of the local image storage elements and one or more of the local patient identifiers corresponding to each of the plurality of patients, a plurality of local location storage elements storing a local index of the patient images stored on the local image storage elements for each of the plurality of patients, the index including a storage location of each study and the corresponding global patient identifier, a global identity storage element, located remotely from the local identity storage elements, storing a global identity list including a global patient identifier for each patient having studies stored in the local image storage elements and a global location storage element, located remotely from the local location storage elements, storing a global index of the patient studies stored on the local image storage elements for each patient, the index including a storage location of each study and the corresponding global patient identifier.

### BRIEF DESCRIPTION OF THE DRAWINGS

FIG. 1 shows an exemplary system for sharing medical information among locations of a federated health care system.

FIG. 2 shows an exemplary method for requesting and retrieving patient information from distributed databases within a federated health care system.

### DETAILED DESCRIPTION

The following exemplary embodiments may be further understood with reference to the following description and the appended drawings, wherein like elements are referred to with the same reference numerals. Described are exemplary systems and methods for integrating PACS from various hospital sites in different locations to form a federated PACS system that allows for data sharing among those various hospital sites.

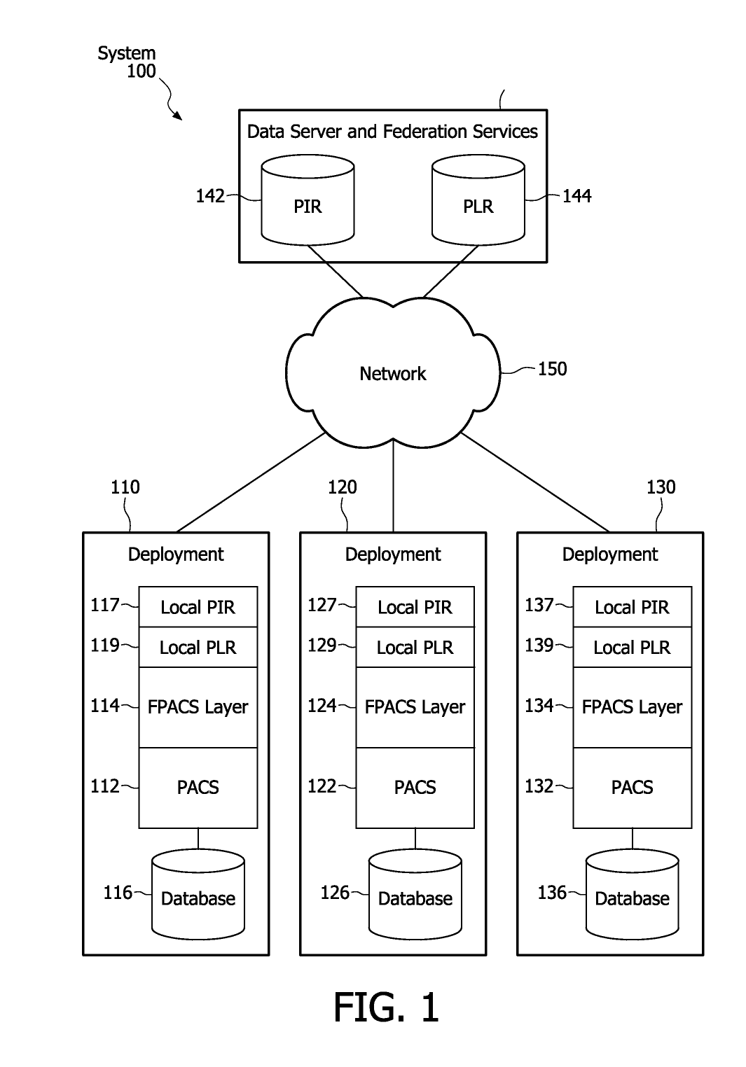

FIG. 1 illustrates an exemplary federated PACS (“FPACS”) system 100. The system 100 includes local FPACS deployments 110, 120 and 130 and a central FPACS data server and federation services 140 (hereinafter referred to as “data server 140”). The deployments 110, 120 and 130 and the data server 140 communicate by means of a network 150 (e.g., a WAN, the Internet). While FIG. 1 illustrates a system 100 with three local deployments, those having skill in the art will understand that this depiction is only exemplary and that other FPACS implementations may include tens or even hundreds of local deployments. Each of the deployments is typically located at a separate hospital site within a federated health care network, or at different departments within the same hospital. Communication among the local deployments 110, 120 and 130 and the data server 140 is conducted using one or a combination of protocols such as Health Level 7 (“HL7”), Digital Imaging and Communications In Medicine (“DICOM”), and other protocols such as standard or proprietary communication protocols.

The PACS deployments 110, 120 and 130 each include PACS 112, 122 and 132, respectively. The PACS 112, 122 and 132 are typically pre-existing systems used to locally index patient images. Each of the PACS 112, 122 and 132 indexes patient images using a local patient identifier (e.g., social security number, insurance policy number, hospital patient ID, etc.) that may differ among the different PACS 112, 122 and 132. The deployments 110, 120 and 130 also include local FPACS communication layers 114, 124 and 134. The communication layers 114, 124 and 134 route data queries between their corresponding local PACS 112, 122 and 132 and the network 150. The deployments 110, 120 and 130 include image databases 116, 126 and 136 where patient images are stored. The deployments 110, 120 and 130 also include local patient identity registries (“PIR”) 117, 127 and 137 (which may be implemented, for example, using cross-referencing (“PIX”) databases) and local patient/study location registries (“PLR”) 119, 129 and 139, which will be described in greater detail below.

The data server 140 includes a global PIR 142 (which is implemented, for example, by a PIX database) and a global PLR 144. The global PIR 142 integrates the various local patient identifiers used by the PACS 112, 122 and 132 into a global database. The global database defines each patient by a global patient identifier and links the global patient identifiers to the various local patient identifiers. Thus, a local FPACS deployment (e.g., the deployment 110) can query the global PIR 142 using the local patient identifier under which a patient is known by its corresponding PACS (e.g., PACS 112) and retrieve the corresponding global patient identifier for that patient.

The global PLR 144 stores, for each patient, all locations where there are studies for that patient. A study contains one image, a series of images, or several series of images originating in one or several modalities, and metadata associated with the one or more images. Patients are identified in the global PLR 144 by the global patient identifiers as defined in the global PIR 142. The global PLR 144 is initially generated by aggregating relevant metadata from each of the PACS 112, 122 and 132 at the time of generation. It may then be updated by adding a new record to the global PLR 144 when a new patient is registered at one of the PACS 112, 122 and 132; when this occurs, the global PIR 142 will also be queried to determine whether the patient is already known using an existing global patient identifier. When a new patient is introduced at a hospital site, he/she is given a new local patient identifier. To detect whether the patient is already known at other sites and identified by a global patient identifier at the global PIR 142, the new patient is matched by comparing demographic data (e.g., name, address, date of birth, etc.) with the patients registered in the global PIR 142 using existing identity matching techniques. By storing only location information for each patient (as opposed to a centralized data storage system containing patient images), the database can be kept at a manageable size. For example, for a federated health care network with ten locations attending one million patients, the solution can be implemented with a maximum database size of ten million rows, in the extreme scenario where all patients have data at all locations, each row simply storing a local patient identifier and a location where there is data for the patient. As a rough estimate, this database could be implemented to have a maximum size of 50 megabytes.

The global PLR 144 can be modified to store a timestamp of the latest study performed at each institution. Thus, through such a modification, it would be possible for database queries to exclude hospital sites holding studies older than a certain threshold date, which can be predetermined, provided by the user, defined in the system based on the preferences of each institution, etc. A global PLR 144 storing timestamps only adds one extra field per database row (in order to store the timestamp), and thus does not result in a significant increase in database size over a more basic global PLR 144 not modified with timestamp capability. An implementation of the global PLR 144 that stores timestamps can be updated each time a new study is introduced into one of the PACS 112, 122 and 132, or at a regular schedule with a predetermined frequency (daily, weekly, etc.).

The global PLR 144 can also be modified to further store relevant metadata in addition to patient location information. Relevant metadata can be useful because the mere fact that a study is recent does not necessarily make it relevant; for example, a patient seeking care at an orthopedic clinic within a health care network may have entirely irrelevant, though recent, prior studies in an eye clinic. Thus, information from metadata about the nature of a study can be helpful. Relevant metadata may include one or more of a study ID, a body part, a modality and an exam code, or other possibilities not described here. The addition of metadata will result in an increase in the size of the database of the PLR 144, but the size will still be within the manageable size limits of a modern database management system. This type of PLR 144 also allows for the generation of a timeline of relevant prior studies for a patient study stored at one PACS (e.g., PACS 112) without sending queries to the other PACS (e.g., PACS 122 and 132) where those prior studies may reside. Studies can then be retrieved at the user's request. As described above, location tables for this type of global PLR 144 can be updated with each new study or at desired regular intervals (e.g., at night or over weekends in order to take advantage of lighter traffic on the network 150).

The local PIRs 117, 127 and 137 store subsets of the global PIR 142 at the local deployments 110, 120 and 130. The subsets are defined to contain the global patient identifiers and the corresponding local patient identifiers for all patients that also have a local patient identifier at the current location. For example, the local PIR 117 stores the subset of the global PIR 142 selected to include all global and local patient identifiers of all patients that also have a local patient identifier in the PACS 112. In other words, the PIR 117 stores the global patient identifiers and all existing local patient identifiers for all patients that have had studies performed at the location of the deployment 110. This may be represented using the following SQL query, in which PIR represents the PIR 142, PID represents a global and/or local patient identifier, PLR represents the global PLR 144, and PACS represents the local PACS 112:
Select * from PIR where PID in (select PID from PLR where location=“PACS”)

The local PLR databases 119, 129 and 139 similarly store subsets of the global PLR 144. At each local deployment, this subset includes the portion of the index containing pointers to locations storing images of patients that have a local patient identifier at the current location, except for those images stored at the same location. For example, the local PLR 119 stores the subset of the global PLR 144 selected to include global patient identifiers and pointers to all locations storing images of patients that have a local patient identifier in the PACS 112, except for those referring to studies contained in the database 116. In other words, the PLR 119 stores pointers to locations storing studies for all patients that have had studies performed at the location of the deployment 110, except for location information concerning those images pertaining to studies performed at the location of the deployment 110 and thus stored locally rather than remotely.

The records stored in the local PLRs 119, 129 and 139 may contain, in addition to global patient identifiers and location information, time stamps of the latest study executed at the referred remote location for the patient, or additional relevant study metadata (e.g., modality, study identifier, exam code, body part, etc.). When relevant metadata is maintained, the local PLR 119, 129 or 139 contains one index (record) for each patient remote study. For systems that include a global PLR 144 that stores either time stamps or full metadata, as described above, the local PLR databases 119, 129 and 139 also store time stamps or full metadata for their appropriate subset of the index. The construction of the local PLR can be represented using the following SQL query, which uses the same designations as above:
Select * from PLR where location< > “PACS” and PID in (select PID from PLR where location=“PACS”)

The local PIRs 117, 127 and 137 and the local PLR databases 119, 129 and 139 are originally established when the global PIR 142 and the global PLR 144 are created to link the various local PACS locations. Subsequently, they are periodically updated with current data. Updates are preferably done infrequently and in bulk rather than more frequently at the time queries are pending. Thus, updates are typically done at times of light network loading (e.g., overnight, on weekends, etc.). Updates may be “pushed” from the global PIR 142 and the global PLR 144 or may be “pulled” by the local deployments. By storing this relevant subset locally, network traffic due to queries can be minimized, and a timeline with relevant prior studies for each study can be built without querying the data server 140. Therefore, this timeline can also be built reliably when the local deployment is disconnected from the network 150 for a short period of time. When the local deployment stays disconnected for longer period, the timeline built based exclusively on local information may become outdated.

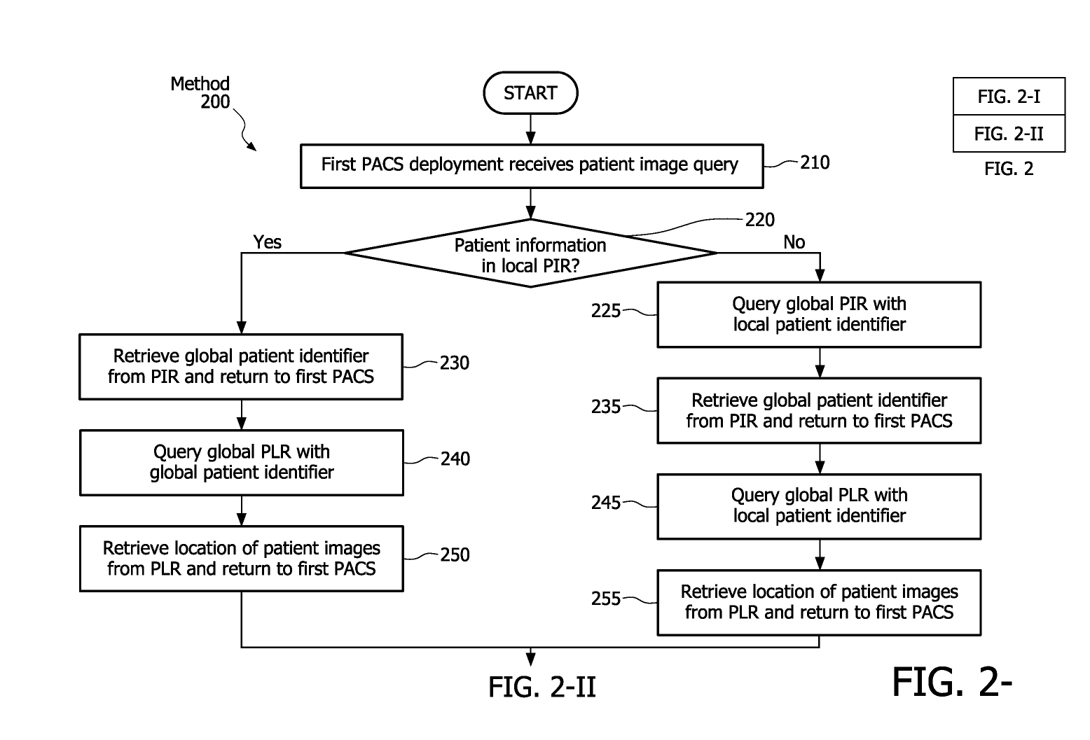

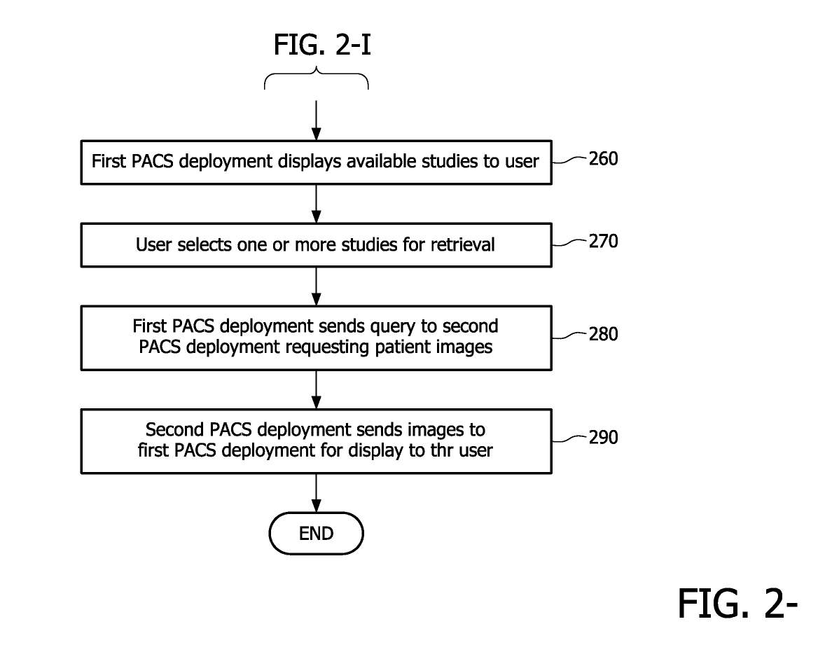

FIG. 2 shows an exemplary method 200 for routing a query for patient images. The method 200 is initiated, for example, by a user of one of the local PACS 112, 122 and 132 of FIG. 1; the description herein refers to a query initiated by a user of PACS 112. In step 210, the PACS 112 receives a query for patient information from a user (e.g., a doctor, a nurse, a testing technician, or other type of clinician, etc.). The query received in step 210 identifies the patient with a local patient identifier that is local to the PACS 112, as described above. Depending on the type of global PLR 144 that is implemented with the system 100, the query may also include a timestamp cutoff point (for a global PLR 144 that stores timestamps) or a search criterion corresponding to the nature of the information that the user wishes to retrieve (for a global PLR 144 that stores full metadata).

In step 220, the PACS 112 queries its local PIR 117 to determine whether there is a locally stored global patient identifier corresponding to the local patient identifier used in step 210. As described above, a patient who has previously received treatment at the location of the PACS 112 will be indexed in the local PIR 117 with a global patient identifier and one or more corresponding local patient identifiers; however, a patient who has been treated elsewhere in the federated healthcare network but not at the current location will not be indexed. If the patient is indexed in the local PIR 117, the method proceeds to step 230, wherein the local PIR 117 returns the global patient identifier for the patient to the PACS 112.

Subsequently, in step 240, the PACS 112 generates a query and sends it to a subset of the local PLR 119. This second query identifies the patient by the global patient identifier received in step 230. For a basic implementation of the global PLR 144 and its subsets in local PLRs 119, 129 and 139, solely the global patient identifier is required for this query. Alternately, for a global PLR 144 and its subsets in local PLRs 119, 129 and 139 storing timestamp information, the query would include the global patient identifier and the desired timestamp cutoff submitted by the user in step 210. Similarly, for a global PLR 144 and subsets in local PLRs 119, 129 and 139 storing full metadata information, the query would include the global patient identifier and the search criterion or criteria corresponding to the metadata as selected by the user in step 210.

Next, in step 250, the local PLR 119 retrieves information and returns it to the PACS 112. The information retrieved corresponds to the global patient identifier as retrieved in step 230 and transmitted in step 240, and provides the PACS 112 with all the locations of studies for the patient. For example, the patient may have had studies previously recorded at the hospital sites corresponding to PACS 122 and 132 (i.e., stored in databases 126 and 136). Locations are provided to the PACS 112 in the form of network addresses (e.g., IP addresses, network paths, etc.). In other implementations of the local PLR 119, added functionality is added to this retrieval. In a local PLR 119 implementation with timestamp records, only locations storing studies more recent than a certain threshold may be provided in response to the query; in a local PLR 119 storing full metadata records, only locations of studies relevant to the search terms may be provided. For example, assume that the patient whose records are currently being searched at the location of the PACS 112 was treated for a broken leg two years ago at the location of PACS deployment 120 and for glaucoma four years ago at the location of PACS deployment 130. A local PLR 19 that supports timestamp searching may return the location of the study in PACS 122 (i.e., in database 126) if the search has specified a cut-off point of three years. However, if the patient is seeking treatment for an eye condition, a local PLR 119 that stores all relevant metadata may be searched with a query that returns the location of the study in PACS 132 (i.e., in database 136), though it is less recent. Those having skill in the art will understand that a local PLR 119 that stores all metadata may also support the ability to search by timestamp or by any of the other stored metadata.

If, in step 220, it is determined that the patient is not indexed in the local PIR 117 (i.e., the patient has not previously been known in the local system, so the global patient identifier, if any, is not known), the method proceeds to step 225, where a query is sent to the global PIR 142 requesting the same information. The query is sent from the PACS 112 to its corresponding FPACS communication layer 114, via the network 150, to the GLOBAL PIR 142. As described above, one or more protocols such as HL7, DICOM, and other standard or proprietary protocols may be used. In step 235, the global PIR 142 retrieves the global patient identifier, corresponding to the local patient identifier used in step 210, and returns it to the PACS 112 in the same manner as step 225.

Next, in step 245, the PACS 112 generates a query, similar to that sent to the local PLR 119 in step 240, and sends it to the global PLR 144. As described above for step 235, transmission is accomplished via the FPACS communication layer 114 and the network 150. In step 255, the global PLR 144 retrieves data in response to the query of step 245 and returns it to the PACS 112 via the network 150 and the FPACS layer communication 114. Data retrieved in step 255 will be similar to that retrieved in step 250, discussed above. After step 255 is completed, the method continues with step 260.

In step 260, the results of the query sent in step 240 or step 245 are provided to the user of the PACS 112 (e.g., in a timeline). For a basic global PLR 144 and subsets in PLRS 119, 129 and 139, the results are simply a list of locations (e.g., for the example described above, the user would be informed that the patient has one previous study in the database 126 and one in the database 136). For a timestamp global PLR 144 and subsets in PLRs 119, 129 and 139, the list would be provided with locations and corresponding timestamps (e.g., for the example described above, the user would be informed that the patient has a previous study stored in database 126, together with the date that study occurred; as described above, the study stored in database 136 would not be returned because it is beyond the specified time threshold). For a full metadata global PLR 144 and subsets in PLRS 119, 129 and 139, the provided list would include locations, timestamps, and any other metadata corresponding to the retrieved records (e.g., for the example described above, the user would be informed of the prior treatment for glaucoma and its corresponding images stored at the location of PACS deployment 132; the prior study undertaken at the location of PACS 122 would not be returned because it is not relevant to the search the user is performing.)

In step 270, the user of PACS 112 selects one or more studies from those provided in step 260 for retrieval. In another exemplary embodiment, all relevant studies may be prefetched for the user's viewing. This selection may be accomplished by selecting studies from a list or timeline (e.g., with a mouse), selecting a “retrieve all” command, or any other process known in the art. In step 280, the request is sent by the FPACS communication layer 114, via the network 150, to the location where images are stored. For example, if the images to be retrieved are located in database 126, the request would be passed from FPACS communication layer 114, through the network 150, to the FPACS layer 124, the PACS 122, and the database 126. This request is not transmitted to or through data server 140, as the location information has already been extracted. In step 290, the requested images are transmitted from their storage location (e.g., database 126) to the requesting user, via the same data path, and displayed to the user. Those of skill in the art will understand that display to the user may include the option to print images, etc. Following step 290, the method 200 terminates. Those of skill in the art will understand that the method 200 may terminate prior to this step if, at any point, no results are returned in response to a database query.

By storing studies locally at various PACS sites while storing indexes at a central location, a very efficient data sharing system can be provided. This type of system is scalable to large systems including tens or hundreds of hospitals and allows a physician at any participating hospital to retrieve images located at any other hospital within the system. Further, by storing subsets of the indexes locally at each of the PACS sites, network usage may be minimized at peak times when queries are typically being sent.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

It is also noted that the claims may include reference signs/numerals in accordance with PCT Rule 6.2(b). However, the present claims should not be considered to be limited to the exemplary embodiments corresponding to the reference signs/numerals.

What is claimed is:

1. A system, comprising:
a local image storage element (112, 122, 132) storing patient studies, each patient study being indexed by a local patient identifier;
a local identity storage element (117, 127, 137) storing a local identity list including a global patient identifier corresponding to each of a plurality of patients having studies stored on the local image storage element (112, 122, 132) and one or more of the local patient identifiers corresponding to each of the plurality of patients, wherein the local identity list is a subset of a global identity list stored remotely from the local identity storage element (117, 127, 137); and
a local location storage element (119, 129, 139) storing a local index of the patient studies stored on the local image storage element (112, 122, 132) and further patient studies stored on further local image storage elements (112, 122, 132) for each of the plurality of patients, the index including a storage location of each study and the corresponding global patient identifier, wherein the local index is a subset of a global index stored remotely from the local location storage element (112, 122, 132).

2. The system of claim 1, wherein the local identity storage element (117, 127, 137) receives a query from the local image storage element (112, 122, 132), the local identity storage element (117, 127, 137) determining if the query includes one of the local patient identifiers in the local identity list and returns a corresponding one of the global patient identifiers.

3. The system of claim 2, wherein the local location storage element (119, 129, 139) receives a further query from the local image storage element (112, 122, 132) including the returned one of the global patient identifiers and returns a listing of patient studies of the patient identified by the returned one of the global patient identifiers, the listing including the storage location of each patient study.

4. The system of claim 2, wherein, if the query includes a local patient identifier not included in the local identity list the local image storage element (112, 122, 132) redirects the query to the global identity list and receives a response including a corresponding one of the global patient identifiers.

5. The system of claim 4, wherein the local image storage element (112, 122, 132) sends a further query including the returned one of the global patient identifiers to the global index and receives a further response including the storage the storage location of each patient study.

6. The system of claim 1, wherein the local index and the global index include one of time stamps and metadata.

7. A method, comprising:
sending (210) a first query including a local patient identifier;
determining (220) whether a local identity list includes the local patient identifier;
receiving (230), when the local identity list includes the local patient identifier, a global patient identifier stored in the local identity list corresponding to the local patient identifier; and
sending (225), when the local identity list does not include the local patient identifier, the first query to a global identity list stored remotely from the local identity list, wherein the local identity list is a subset of the global identity list.

8. The method of claim 7, further comprising:
receiving (235) from the global identity list a global patient identifier stored in the global identity list corresponding to the local patient identifier.

9. The method of claim 7, further comprising:
sending (240) a second query including the one of the global patient identifiers received from the local identity list to a local index, wherein the local index is a subset of a global index stored remotely from the local index; and
receiving (250) from the local index a listing of patient studies corresponding to the one of the global patient identifiers, the listing including a storage location of each patient study.

10. The method of claim 9, further comprising:
displaying (260) the listing.

11. The method of claim 9, wherein the storage location is one of local and remote from a location where the index is stored.

12. The method of claim 8, further comprising:
sending (245) a second query including the one of the global patient identifiers received from the global identity list to a global index; and
receiving (255) from the global index a listing of patient studies corresponding to the one of the global patient identifiers, the listing including a storage location of each patient study.

13. The method of claim 12, further comprising:
displaying (260) the listing.

14. A system, comprising:
a plurality of local image storage elements (112, 122, 132) storing patient studies, each patient study being indexed by a local patient identifier;
a plurality of local identity storage elements (117, 127, 137) storing a local identity list including a global patient identifier corresponding to each of a plurality of patients having studies stored on a corresponding one of the local image storage elements (112, 122, 132) and one or more of the local patient identifiers corresponding to each of the plurality of patients;
a plurality of local location storage elements (119, 129, 139) storing a local index of the patient images stored on the local image storage elements (112, 122, 132) for each of the plurality of patients, the index including a storage location of each study and the corresponding global patient identifier;
a global identity storage element (142), located remotely from the local identity storage elements (117, 127, 137), storing a global identity list including a global patient identifier for each patient having studies stored in the local image storage elements (112, 122, 132); and
a global location storage element (144), located remotely from the local location storage elements (119, 129, 139), storing a global index of the patient studies stored on the local image storage elements (112, 122, 132) for each patient, the index including a storage location of each study and the corresponding global patient identifier.

15. The system of claim 14, wherein the local identity list is a subset of a global identity list.

16. The system of claim 14, wherein the local index is a subset of a global index.

17. The system of claim 14, wherein one of the local image storage elements (112, 122, 132) sends a query including one of the local patient identifiers to a corresponding one of the local identity storage elements (117, 127, 137) which determines if local identity list includes the one of the local patient identifiers and returns a corresponding one of the global patient identifiers to the local image storage element (112, 122, 132) if the local patient identifier is includes in the local identity list.

18. The system of claim 17, wherein the one of the local image storage elements (112, 122, 132) sends a further query including the returned one of the global patient identifiers to a corresponding one of the local location storage elements (119, 129, 139) which returns a listing of patient studies of the patient identified by the returned one of the global patient identifiers, the listing including the storage location of each patient study.

19. The system of claim 17, wherein, if the query includes a local patient identifier not included in the local identity list the one of the local image storage elements (112, 122, 132) redirects the query to the global identity storage element (142) which returns a corresponding one of the global patient identifiers.

20. The system of claim 19, wherein the one of the local image storage elements (112, 122, 132) sends a further query including the returned one of the global patient identifiers to the global location storage element (144) which returns the storage location of each patient study.
